(19) United States
(12) Patent Application Publication
(10) Pub. No.: US 2006/0222020 A1
(43) Pub. Date: Oct. 5, 2006

(54) Time start in the forward path

(75) Inventors: John M. Hedin, Coon Rapids, MN (US); Donald R. Bauman, Waseca, MN (US); Jeffrey J. Cannon, St. Louis Park, MN (US)

Correspondence Address: FOGG AND ASSOCIATES, LLC, P.O. BOX 581339, MINNEAPOLIS, MN, 55458-1339, US

(73) Assignee: ADC Telecommunications, Inc., Eden Prairie, MN (US)

(21) Appl. No.: 11/095,113

(22) Filed: Mar. 31, 2005

(51) Int. Cl. H04J 3/06

(52) U.S. Cl. 370/509

(57) ABSTRACT

The synchronization of timing between devices in a communication system is presented. In particular, in one embodiment, a method of synchronizing timing of communications between a software module and a host card in a forward direction is presented. The method comprises reading a time start message in a header of a page of data received from the software module and transmitting the page of data when the time start message matches a time of a time clock in the host card.

### CROSS REFERENCES TO RELATED APPLICATIONS

This application is related to the following co-pending United States patent applications filed on even date herewith, all of which are hereby incorporated herein by reference:

U.S. patent application Ser. No. ______ (attorney docket number 100.672US01 entitled “DYNAMIC FREQUENCY HOPPING”) and which is referred to here as the '672 application;

U.S. patent application Ser. No. ______ (attorney docket number 100.673US01 entitled “DYNAMIC DIGITAL UP AND DOWN CONVERTERS”) and which is referred to here as the '673 application;

U.S. patent application Ser. No. ______ (attorney docket number 100.675US01 entitled “DYNAMIC RECONFIGURATION OF RESOURCES THROUGH PAGE HEADERS”) and which is referred to here as the '675 application;

U.S. patent application Ser. No. ______ (attorney docket number 100.676US01 entitled “SIGNAL ENHANCEMENT THROUGH DIVERSITY”) and which is referred to here as the '676 application;

U.S. patent application Ser. No. ______ (attorney docket number 100.677US01 entitled “SNMP MANAGEMENT IN A SOFTWARE DEFINED RADIO”) and which is referred to here as the '677 application;

U.S. patent application Ser. No. ______ (attorney docket number 100.678US01 entitled “TIME STAMP IN THE REVERSE PATH”) and which is referred to here as the '678 application;

U.S. patent application Ser. No. ______ (attorney docket number 100.679US01 entitled “BUFFERS HANDLING MULTIPLE PROTOCOLS”) and which is referred to here as the '679 application;

U.S. patent application Ser. No. ______ (attorney docket number 100.681US01 entitled “LOSS OF PAGE SYNCHRONIZATION”) and which is referred to here as the '681 application;

U.S. patent application Ser. No. ______ (attorney docket number 100.684US01, entitled “DYNAMIC REALLOCATION OF BANDWIDTH AND MODULATION PROTOCOLS” and which is referred to here as the '684 application;

U.S. patent application Ser. No. ______ (attorney docket number 100.685US01 entitled “DYNAMIC READJUSTMENT OF POWER”) and which is referred to here as the '685 application;

U.S. patent application Ser. No. ______ (attorney docket number 100.686US01 entitled “METHODS AND SYSTEMS FOR HANDLING UNDERFLOW AND OVERFLOW IN A SOFTWARE DEFINED RADIO”) and which is referred to here as the '686 application; and

U.S. patent application Ser. No. ______ (attorney docket number 100.700US01 entitled “INTEGRATED NETWORK MANAGEMENT OF A SOFTWARE DEFINED RADIO SYSTEM”) and which is referred to here as the '700 application.

### TECHNICAL FIELD

The present invention relates generally to communication systems and in particular to the synchronization of timing between devices in a communication system.

### BACKGROUND

Wireless telecommunications systems, particularly cellular telephone communications systems, employ strategically placed base stations having transceivers that receive and transmit signals over a carrier frequency band to provide wireless communications between two parties. Recent mobile communication standards have lead to a plurality of different modulation standards being in use within a geographic region. Wireless communication providers have had to adapt their network hardware to accommodate unique protocols associated with each modulation standard. Some modulation standards that wireless communication networks currently operate with include, but are not limited to, Advanced Mobile Phone System (AMPS), code division multiple access (CDMA), Wide-band CDMA (WCDMA), time division multiple access (TDMA), Global System for Mobile communications (GSM), Cellular Digital Packet Data (CDPD), Enhanced Data rates for GSM Evolution (EDGE), General Packet Radio Service (GPRS), Integrated Digital Enhanced Network (iDEN), and Orthogonal Frequency Division Multiplexing (OFDM).

Call processing software, controlled by the base station server, handles large amounts of data. The call processing software receives the data from the base station as well as from the host cards through communication channels. An issue that has to be dealt with in this type of communication system is how to handle the data in the channels as well as the synchronization of the channels between the call processing software and the host cards. One approach to handling this data is by working on all the channels sequentially. This approach, however, requires either a single processor for each channel or an incredibly fast processor that can hop between packets of information. This approach is very expensive and inefficient. Another approach is the use of batch processing. This allows for a general purpose processor which can work on multiple channels at a time. However, general purpose processors have their own clocks and communication between these and host cards are complicated by problems with time synchronization.

For the reasons stated above, and for other reasons stated below that will become apparent to those skilled in the art upon reading and understanding the present specification, there is a need in the art for an effective way of maintaining time synchronization in an efficient manner.

### SUMMARY

The above-mentioned problems and other problems are resolved by the present invention and will be understood by reading and studying the following specification.

In one embodiment, a method of synchronizing timing of communications between a software module and a host card is presented. The method comprises reading a time start message in a header of a page of data received from the software module and transmitting the page of data when the time start message matches a time of a time clock in the host card.

In another embodiment, a method of synchronizing the time of communications in a communication system is presented. The method comprises calculating a time start message based in least in part on a time stamp in a received page of data and a delay. Embedding the time start message in a header of a transmit page containing data samples. Comparing the time start message with a then current time from a time clock in an interface card and when the time start message matches the then current time of the time clock within a select tolerance, transmitting the data samples to a remote head.

In still another embodiment a host card for a communication system is presented. The host card includes at least one inbound buffer, a time clock, comparative circuitry and a transmit engine associated with each inbound buffer. The at least one inbound buffer is adapted to receive pages of data samples from a processing module. Each page of data includes a time start message in a header. The compare circuitry is adapted to compare a then current time from the time clock with a time start message in a header of a page of data. In addition, each transmit engine is adapted to transmit an associated page of data when the compare circuitry determines that the then current time matches a time start message in a header of the page of data.

In further another embodiment, a communication system comprises a radio head unit and a server. The radio head unit is adapted to transmit and receive data samples from one or more communication devices. The server is in communication with the radio head card. The server includes a call processing module and at least one interface card. The call processing module is adapted to process communication signals. The at least one interface card in communication with the call processing module. Moreover, each interface card includes a synchronization circuit adapted to synchronize the timing of communication signals between the call processing module and the interface card.

In still further another embodiment, a communication system is provided. The communication system includes a means for determining a time to start transmission of a page of data samples, a means for embedding a time start message of the time to start transmission of the page of data in a header of the page of data, a means of comparing the time start message with a time of a time clock in a host card and a means of transmitting the page of data when the time start message matches the time of the time clock within select tolerances.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a block diagram of a communication system of one embodiment of the present invention;

FIG. 2A is a block diagram of a time synchronization system of one embodiment of the present invention;

FIG. 2b is a block diagram illustrating a forward path in one embodiment of the present invention;

FIG. 3 is an illustration of a time synchronization system of one embodiment of the present invention; and

FIG. 4 is a flow chart illustrating a time synchronization of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description of the preferred embodiments, reference is made to the accompanying drawings, which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide methods and systems of providing time synchronization and easy communication between host cards and call processing software modules. This allows for a general purpose server to perform batch processing and be more efficient in handling data with the call processing software. Time synchronization circuitry inside the radio head interface card (host card) helps to provide synchronization.

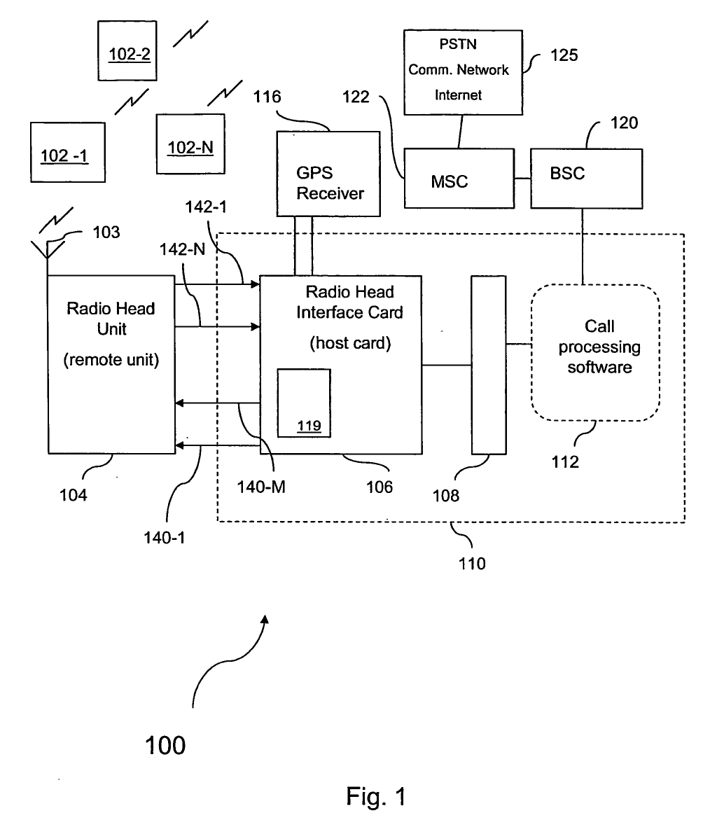

FIG. 1 is a block diagram of one embodiment of a communication system shown generally at 100 of the present invention. Communication system 100 includes one or more subscriber units 102-1 through 102-N (or mobile devices 102-1 through 102-N) within a service area of a radio head unit 104. Radio unit 104 is coupled to one or more servers 110 over a plurality of transport mediums 140-1 through 140-M in a forward direction and 142-1 through 142-N in a backward direction. Server 110 is connected to one or more communication networks 125 (e.g. the public switched telephone network (PSTN), Internet, cable network, or the like). In one embodiment, communication system 100 further includes a base station controller (BSC) 120 coupled to server 110. In another embodiment, BSC 120 is further coupled to a mobile switching center (MSC) 122. BSC 120 supervises the functioning and control of the call processing of server 110. In one embodiment, BSC 120 is a radio network controller.

As illustrated in FIG. 1, radio head interface card 106 is coupled to the call processing software 112 via interface 108. In one embodiment, the radio head interface card 106 is a PCI-X card and the interface 108 is a PCI-X bus 108. The radio head interface card 106 communicates with one or more communication networks 125 via call processing software 112. In one embodiment, each time the BSC 120 initiates frequency hopping, changing bandwidths, or changing amplitudes for one of the logical channels, the call processing software 112 (or call processing module) provides information to radio head interface card 106. In order to keep in unison, time synchronization between the call processing software 112 and the head interface card 106 is required. Embodiments of the present invention provide the synchronization. In one embodiment, the time synchronization is performed in part by a synchronization circuit 119 that is located in the radio head interface card 106 (or host card 106).

In one embodiment, the radio head interface card 106 is adapted with a global positioning system (GPS) receiver 116 to receive GPS time pulses. The received time pulses are used to control the internal time count of radio head interface card 106. The internal time count is used by the synchronization circuit 119 to synchronize communication between the server 110, the call processing module 112 and the radio head interface card 106. Although, this embodiment employs a GPS server to receive time pulses, other embodiments, employ other systems known in the art to receive time pulses.

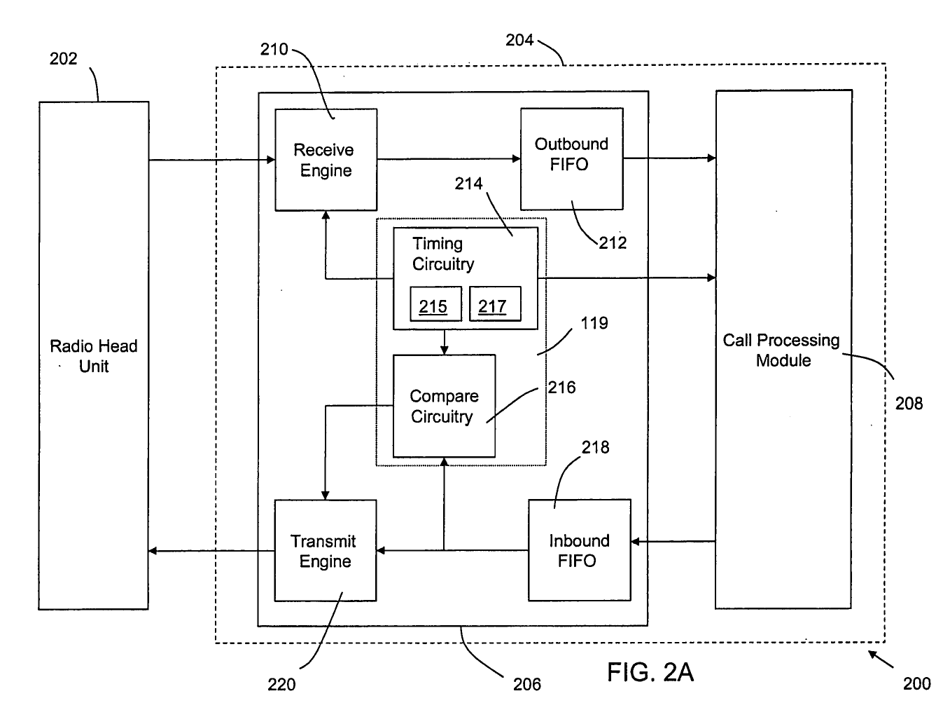

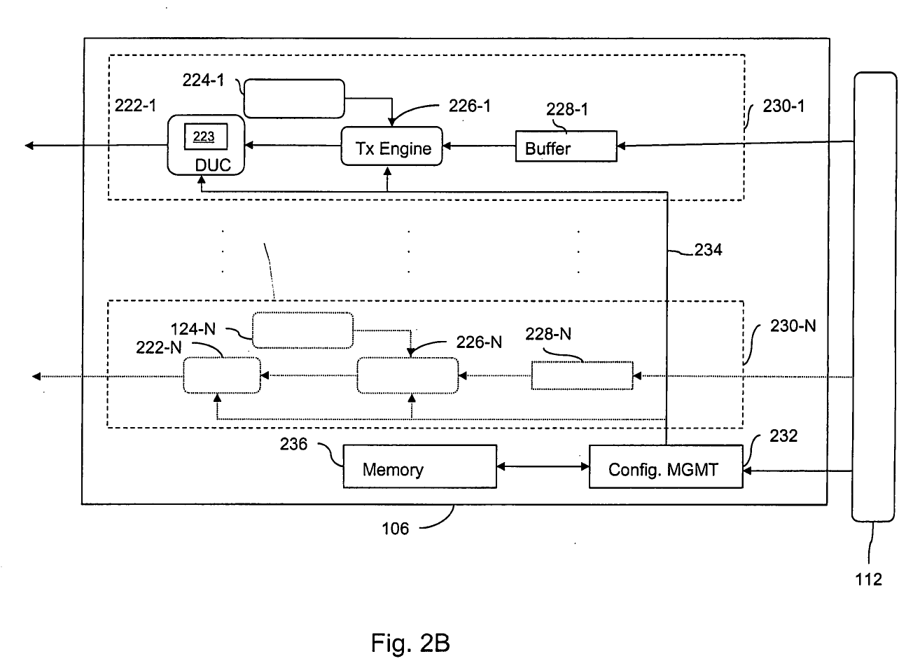

FIG. 2A is a block diagram of a time synchronization system shown generally at 200 of one embodiment of the present invention. As illustrated, a call processing module 208 is coupled to radio head interface card 206 which, in this embodiment, is located inside server 204. The call processing module 208 and the radio head interface card 206 are in communication with each other. The time used by the call processing module 208 (batch process time) and the time used by the radio head interface card 206 (real time) is different. Embodiments of the present invention synchronize the timing of messages between the call processing module 208 and the radio head interface card 206 with the help of a synchronization circuit 119 so that frequency hopping, bandwidth changing, protocol changing and the like are handled properly.

In one embodiment, data transmitted in a forward path is transmitted from the call processing module through the radio head interface card 206 to the radio head unit 202. The forward path in the radio head interface card 206 includes an inbound FIFO 218 and a transmit engine 220. Compare circuitry 216 is used to control when the transmit engine 220 transmits data. The Compare circuitry 216 is adapted to read a time start message embedded in a header of a page of data samples and compare it with a time clock 215 in timing circuitry 214. Once the time from the time clock 215 matches the time start message, the transmit engine begins transmitting the data to the radio head unit 202. Although, only one transmission path is illustrated in FIG. 2A, multiple paths or channels can be used each having there own buffers and transmit engines. For example, referring to FIG. 2B multiple forward paths through an interface card 206 is illustrated. As illustrated, multiple logic channels 230-1 through 230-M (multiple forward paths) are present in this embodiment. The logic channels 230-1 through 230 M include associated buffers 228-1 through 228-M and transmit engines 226-1 through 226-M.

To provide a better understanding of a forward path, a description of how the data flows through channel 230-1 in one embodiment of the present invention is provided. In a forward path, the call processing module 208 compiles voice and data information from a communication network or from the radio head interface card into pages of complex RF samples (pages of data). A page of data is sent through an associated logical channel 230-1 to an associated transmit buffer 228-1. In one embodiment, the buffer 228-1 is a FIFO 228-1. In embodiments of the present application, the transmit buffers are continuously monitored for “buffer underflow.” Buffer underflow occurs when the buffer becomes empty. When a buffer overflow condition occurs the buffer sends zeros to the transmit engine. If more than one page of zeros are sent after a buffer overflow condition occurs, a time start message needs to be sent to restart the process. Underflow is further described in application number 100.686US01 which is herein incorporated by reference.

From the buffer 228-1, the data is transferred to transmit engine 226-1. Since the passing of the data is controlled by different clocks on different sides of the buffer 228-1 (i.e. batch processing timing by the call processing module 208 and real time by the interface card 206), synchronization of when the transmit engine 226-1 should transmit the data is required. A time synchronization circuit 224-1 in this embodiment controls when the transmit engine 226-1 is to transmit the data to an associated digital up converter (DUC) 122-1 and then out to a radio head unit. In this embodiment, the call processing module 208 includes in a page header with a time start message. The time synchronization circuit 224-1 is adapted to read the time start message and compare it with the current time in the clock of the interface card 206. When the time start message matches the time from the time clock, the time synchronization circuit 224-1 directs the transmit engine 226-1 to start transmission. Also illustrated in FIG. 2B is a memory 236 to hold filter coefficients and sample rates for the DUC 222-1 and a configuration management unit 232. The configuration management unit 232 is adapted to look up associated filter parameters and sampling rates in the memory and apply them to the DUC 222-1 to change to protocol of the data that is transmitted by the transmit engine 226-1. This allows for frequency hopping.

In one embodiment, synchronization is initiated by a flag that is also imbedded in the page header (or information page header). In this embodiment, the call processing module 208 embeds a flag in a page header that is sent to the inbound FIFO 218. This flag can be referred to as the Time Start Indicator (TSI). The TSI is either set to a “1” which in one embodiment indicates that a time start is to be observed, or a “0” which in one embodiment indicates the time start is to be ignored. In this embodiment, when the time synchronization circuit 224-1 encounters a “0” TSI the data is transmitted by the transmit engine 226-1 as soon as it is received. When the time synchronization circuit 224-1 encounters a “1” TSI the time start in the header is read and the transmit engine 226-1 transmits the data when the time clock matches the time start message.

Referring back to FIG. 2A, communication signals in a reverse path of this embodiment is discussed. As illustrated, communication signals (audio and video) data is sent from the radio head unit 202 to a receive engine 210 in the radio head interface card 206. In one embodiment the communication signals are complex RF data samples. The timing circuitry 214 includes a time clock 215 and a time stamp generator 217. The time stamp generator 217 is adapted to generate a time stamp message. The time stamp message (or time stamp) includes the value of the time clock 215 at the receipt of a first data sample at the receive engine 210. The time stamp is placed in the data samples at the receive engine 210. A page of complex RF data samples is formed by the outbound FIFO. The page of data includes the time stamp in a header. The call processing module uses the time stamp to determine when the data was received by the receive engine and to synchronize timing of communications based at least in part on the time stamp.

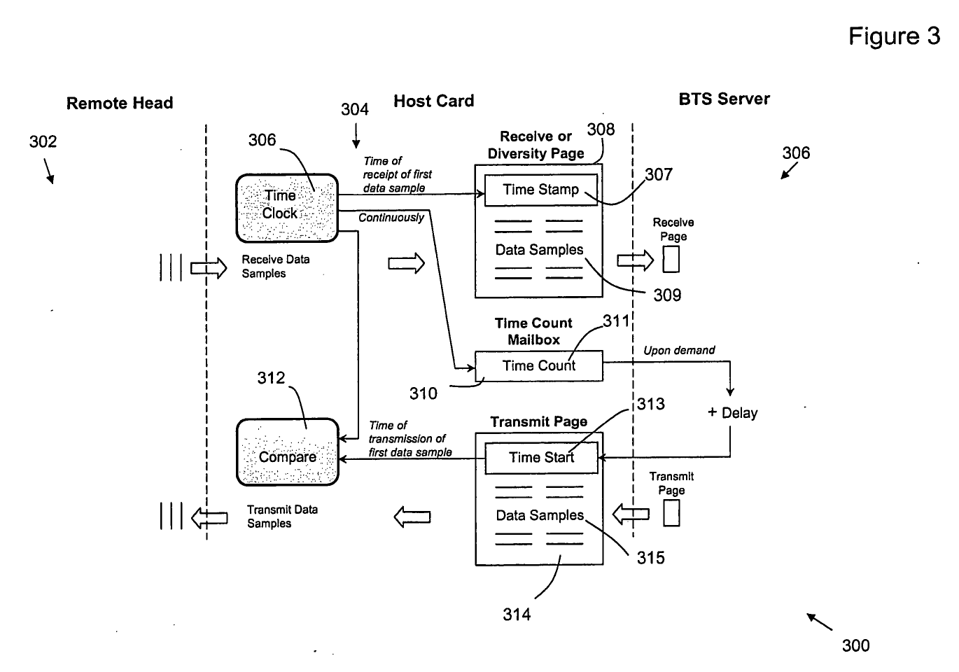

FIG. 3, illustrates a time synchronization system shown generally at 300 of one embodiment of the present invention. In particular, this embodiment illustrates the steps involved in synchronization. As illustrated, complex data samples from the remote head 302 are passed to the host card 304. The time the first data sample is received by the host card, as determined by the time clock 306 in the host card 304, is placed, via a time stamp 307, in a receive or diversity page 308 formed in a buffer. The receive page 308 also includes the data samples 309 which are associated with the time stamp. As illustrated, the time clock 306 also provides a time count 311 which is stored in a time count mail box 310. The time count 311 reflects a period time sampling of the time clock 306 which is continuously updated. The BTS server 306 which include the software module, uses the time stamp 307 in the receive engine to determine when the data samples were received by the host card 304. The server 306 further uses the time count 311 in the time count mailbox 310 to calculate a desired time start to be placed in the header of a select page of data (the transmit page 314).

In one embodiment, a delay based in least in part on the time count 311 in the time count mailbox 310 is used to determine a desired time start 313 of a transmission page 314. Further in one embodiment, the time clock 306 is run at a 71 MHz rate and is incremented modulo 71,000,000. The time delay is exemplified in this embodiment by the following equation: time start=(time start+delay) modulo 71,000,000. A valid delay number range is between zero and 33,554,431 in this embodiment. The maximum delay, called Max Delay is slightly less than half the time stamp number range and slightly less than half a second (about 0.473 seconds). Actual transmission time has a granularity of +/−the data sample time. If the time start indicator (TSI) located within the transmit page 314 is active the time start is observed. Otherwise, it is ignored and data samples are sent contiguously. That is, the first RF data sample of the new page 314 is sent immediately after sending of the last data sample of the previous page 314 when the time start is being ignored. If the time start is not to be ignored, the host card 304 compares 312 the time start to the current time clock 306. If they match, the first data sample from the transmit page 314 is sent and subsequent data samples from the page 314 follow.

A match between the time clock 306 and the time start 313 is defined as agreement within the data sample tolerance (or range). The data sample tolerance in one embodiment is +/−½ the number of time clocks between data samples. As indicated in the above example, in embodiments of the present invention, the time clock 215 within the time circuitry 214 is counting at a much faster than the data sample rate. This allows for a range of time counts that are valid for the same data sample time. In one embodiment, the time clock is a monotonic increasing clock having a time count rate of 71 Mhz. In this embodiment, 70 time counts occur between data samples when the data sample rate is 1.0 Msps. By adding a time offset to the current time, a time start is valid for the current time count and also for the succeeding 70 counts (just before the next data sample time). The transmit engine 220 is adapted to transmit information received from the call processing module 208 to the radio head unit 202 when the time start≦current time+time offset wherein, in the above embodiment, the time offset equals 70.

In another embodiment the clock circuit 215 is a clock rollover. In an embodiment having a clock rollover frequency of 71 MHz, a 32-bit counter is used. This counter naturally rolls over at about 2³² or 4 billion clock pulses (which occurs in about a one minute time frame). However, instead of allowing the counter to rollover naturally, it is reset to zero upon every occurrence of a one second GPS pulse. This effectively makes it 71 million clock pulses (counts) to rollover. In one embodiment only half the range of time counts, centering on zero, are considered a valid count difference. This embodiment accounts for the rollover and the elimination of meaning for past and future times. An eight bit example of this would result in using the following equation: Difference=current time−time start+time offset; −127≦valid difference≦+127. The differences are counted with an absolute value greater than half the total range and are used to detect and correct time rollover. This correction is done using modulo 256 arithmetic. If difference is <−128 then corrected difference=difference+128 (correction one). If difference is >+127, then corrected difference=difference−128 (correction two). Correction one applies if the most significant bit (MSB) is one and any of the other “upper” bits are zero. Correction two applies if the MSB is zero and any of the other “upper” bits are one. Other embodiments, using various sized counters are contemplated and within the scope of the invention. Methods of correcting clock rollover used above are similarly applied in these other embodiments.

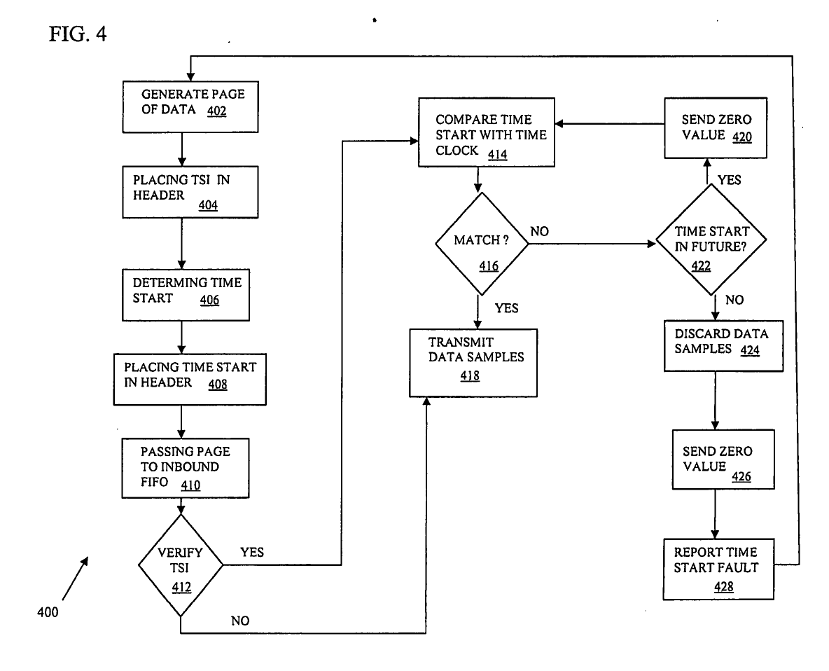

FIG. 4 is a flow chart 400 illustrating a method obtaining time synchronization in a forward path of one embodiment of the present invention. As illustrated, the process starts with the generation of a page of data via call processing module (402). The call processing module then places a TSI flag in the header of the page of data (404). The TSI flag indicates if a time start message in the header is to be read or ignored. The time start is then determined by the call processing module (406). The time start is the time in which the interface card is to transmit the page of data. The time start is then placed in the header of the page of data (408). The page is then passed to an inbound FIFO (410) in the host card (or interface card). The TSI is then verified (412). If the TSI indicates the time start is to be ignored (412), the data samples associated with the header are transmitted right away to a radio head (418). However, if the TSI indicates the time start is to be observed (412), the time start is compared to the current time of a time clock of the interface card (414). If there is a match (416), the data samples associated with the time start are transmitted. However, if there is not a match (416), it is determined if the time start occurs in the future (422). If the time start occurs in the future (422), zeros are transmitted by the interface card (420). The time start is again compared with the then current time of the time clock (414). If there still is not a match (416), it is once again determined if the time start occurs in the future (422). If the time start is in the future 422, the process continues through steps 420, 414 and 416 until there is a match. If it is determined that the time start does not occur in the future (422), the time start must have occurred in the past and the data samples are discarded (424). If this happens, zero values are transmitted (426) and a time start fault is reported (428). The process then generates another page at 402 and the process continues.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of synchronizing timing of communications between a software module and a host card, the method comprising:
reading a time start message in a header of a page of data received from the software module; and
transmitting the page of data when the time start message matches a time of a time clock in the host card.

2. The method of claim 1, wherein the time start message matches a time of the time clock in the host card when they are within a select range of each other.

3. The method of claim 1, further comprising;
when the time start message occurs in the future in relation to the then current time clock, transmitting zero values.

4. The method of claim 1, further comprising:
when the time start message occurs in the past in relation to the then current time clock, discarding data samples; and
reporting time start fault.

5. The method of claim 1, further comprising:
resetting the time clock to zero with a GPS pulse.

6. The method of claim 1, further comprising:
determining the time start message; and
embedding the time start message in the header of the page of data.

7. The method of claim 6, wherein determining the time start message further comprises:
reading a time stamp message in a receive page of data; and
adding a delay to the time stamp message.

8. The method of claim 7, further comprising:
reading a time clock in the host card when a first data sample associated with the first receive page of data is received; and
embedding the time stamp message in the receive page of data.

9. The method of claim 1, further comprising:
reading a time start indicator in the header in the page of data; and
determining if the time start massage should be ignored based on the time start indicator.

10. The method of claim 9, further comprising:
embedding the time start indicator in the header of the page of data.

11. A method of synchronizing the time of communications in a communication system, the method comprising:
calculating a time start message based in least in part on a time stamp in a received page of data and a delay;
embedding the time start message in a header of a transmit page containing data samples;
comparing the time start message with a then current time from a time clock in an interface card; and
when the time start message matches the then current time of the time clock within a select tolerance, transmitting the data samples to a remote head.

12. The method of claim 11, further comprising:
when the time start message occurs in the future in relation to the then current time, transmitting zeros.

13. The method of claim 11, further comprising:
when the time start message occurs in the past in relation to the then current time, discarding associated data samples.

14. A host card for a communication system, the host card comprising:
at least one inbound buffer adapted to receive pages of data samples from a processing module, each page of data including a time start message in a header;
a time clock;
compare circuitry adapted to compare a then current time from the time clock with a time start message in a header of a page of data; and
a transmit engine associated with each inbound buffer, each transmit engine adapted to transmit an associated page of data when the compare circuitry determines that the then current time matches a time start message in a header of the page of data.

15. The host card of claim 14, wherein the compare circuitry is further adapted to determine a match if the then current time is within a select range of the time start message.

16. The host card of claim 14, further comprising:
a time count mail box in communication with the time clock, the time clock mailbox adapted to store the then current time of the time clock, the time count mail box further adapted to pass the then current time count on to the processing module for timing purposes.

17. The host card of claim 14, further comprising:
at least one receive engine adapted to receive complex data samples;
a time stamp generator adapted to read the time of the time clock and embed a time stamp in the data samples that indicates the time a first data sample was received by an associated receive engine; and
an outbound buffer associated with each receive engine, each outbound buffer adapted to output the time stamp and associated data samples to the processing module.

18. The host card of claim 14, wherein the time clock is a monotonic increasing clock.

19. The host card of claim 14, wherein the time clock is a clock rollover adapted to be reset to zero by a time pulse.

20. The host card of claim 19, wherein the time pulse is a GPS time pulse.

21. A communication system comprising:
a radio head unit adapted to transmit and receive data samples from one or more communication devices; and
a server in communication with the radio head card, the server including,
a call processing module adapted to process communication signals, and
at least one interface card in communication with the call processing module, each interface card including a synchronization circuit adapted to synchronize the timing of communication signals between the call processing module and the interface card.

22. The communication system of claim 21, wherein each interface card further comprises:
at least one inbound buffer adapted to receive pages of data samples from the call processing module, each page including a time start message in a header; and
a transmit engine for each inbound buffer, each transmit engine in communication an associated inbound buffer, each transmit engine further adapted to transmit data samples to the radio head unit.

23. The communication system of claim 22, wherein the synchronization circuit further comprises host card further comprising:
a time clock;
compare circuitry adapted to compare a then current time from the time clock with a time start message in a header of a page; and
each transmit engine adapted to transmit data samples associated with the time start message to the radio head unit when the compare circuitry determines that the then current time matches the time start message.

24. The communication system of claim 21, wherein the interface card further comprises:
at least one receive engine adapted to receive complex data samples; and
an outbound buffer for each receive engine, each outbound buffer being in communication with an associated receive engine, each outbound buffer adapted to output a time stamp and associated data samples to the call processing module.

25. The communication system of claim 24, wherein the synchronization circuit further comprises:
a time stamp generator adapted to read the time of the time clock and embed the time stamp in the data samples that indicates the time a first data sample was received by an associated receive engine.

26. The communication system of claim 21, wherein the synchronization circuit further comprises:
a time count mail box in communication with the time clock, the time clock mailbox adapted to store the then current time of the time clock, the time count mail box further adapted to pass the then current time count on to the processing module for timing purposes.

27. A communication system, the communication system comprising:
a means for determining a time to start transmission of a page of data samples;
a means for embedding a time start message of the time to start transmission of the page of data in a header of the page of data;
a means of comparing the time start message with a time of a time clock in a host card; and
a means of transmitting the page of data when the time start message matches the time of the time clock within select tolerances.

28. A method of operating a communication system, the method comprising:
coupling data samples to at least one transmit buffer;
monitoring each transmit buffer for buffer underflow conditions; and
when an underflow condition is encountered, replacing valid data samples with underflow zero data samples.

29. The method of claim 28, further comprising:
reading a time start message in a header of a page of data samples; and
transmitting the page of data samples when the time start message matches a time of a time clock.

30. The method of claim 28, further comprising:
when more than one page of zeros data samples have been sent, waiting for a time start message to restart the process.
